(19) United States
(12) Patent Application Publication
(10) Pub. No.: US 2006/0040562 A1
(43) Pub. Date: Feb. 23, 2006

(54) Connector with built-in substrate and its assembling method

(75) Inventor: Akira Funatsu, Tokyo (JP)

Correspondence Address: TAKEUCHI & TAKEUCHI, Suite 202, 200 Daingerfield Road, Alexandria, VA, 22314, US

(73) Assignee: Hirose Electric Co., Ltd.

(21) Appl. No.: 11/137,481

(22) Filed: May 26, 2005

(30) Foreign Application Priority Data
Aug. 19, 2004 (JP) 2004-239664

(51) Int. Cl. H01R 24/00

(52) U.S. Cl. 439/660

(57) ABSTRACT

A connector with a built-in substrate includes an insulating housing, and a terminal and a substrate, which are secured in the insulating housing. The insulating housing has a substrate mounting section to mount the substrate in the insulating housing, and a terminal mounting section to mount a terminal. The direction of mounting the substrate in the substrate mounting section is same as that of mounting the terminal in the terminal mounting section. According to this invention, there is provided a connector with a built-in substrate, in which the substrate has various functions and can be easily mounted in a connector. In addition, the connector can be easily manufactured, and is comprised of less components.

### BACKGROUND OF THE INVENTION

1. Field of the Invention

The present invention relates to a connector with a built-in substrate and its assembling method.

2. Description of the Related Art

In order to eliminate static electricity, prevent radiation noise, or for other purposes, a substrate having specific function may be provided in a connector. As a method to provide such substrate in a connector, for example, a substrate can be provided by superimposing it onto the outer portion of the connector as disclosed in Unexamined Japan Patent Application Publication H8-106958, or a substrate can be built in the connector as disclosed in Unexamined Japan Patent Application Publication H8-273766. Especially the latter patent publication discloses a connector with a built-in substrate, in which the substrate is built in the connector by attaching the substrate to a bottom plate from the upper side, then placing a housing over the substrate on the bottom plate from the upper side, and securing the substrate onto the bottom plate.
References Cited:

Unexamined Japan Patent Application Publication H8-106958

Unexamined Japan Patent Application Publication H8-273766

As disclosed in the former patent publication, however, if the substrate is simply superimposed over the outer portion of the connector, it is very difficult to securely contact the substrate to the connector, and complicated constitution is required for connecting the substrate outside of the connector with the terminal in the connector. On the other hand, in the method disclosed in the latter patent publication, since the bottom plate is required in addition to the housing, the number of components has to be increased, and a complicated manufacturing process, like attaching the substrate to the bottom plate and then placing the housing over the substrate, is required.

### SUMMARY OF THE INVENTION

Accordingly, it is an object of the invention to provide a connector with a built-in substrate, which has a substrate having various functions, can be easily manufactured, and requires less number of components.

It is another object of the invention to provide a method for assembling such connector.

According to the invention, there is provided a connector with a built-in substrate, which comprises an insulating housing, a terminal and a substrate which are secured in the insulating housing. In this invention, the insulating housing is featured by having a substrate mounting section to mount the substrate in the housing, and a terminal mounting section to mount the terminal in the housing. The mounting direction of the substrate in the substrate mounting section is same as that of the terminal in the terminal mounting section.

In the above connector, a positioning member for positioning the substrate in the substrate mounting section when the substrate is mounted in the substrate mounting section can be provided in the substrate mounting section. The positioning member can be a press-in rib, which is provided along the mounting direction of the substrate so that the substrate is pressed in and secured in the insulating housing being pushed by the substrate when the substrate is mounted in the substrate mounting section. An elastic bar having a free end can be formed at a part of the terminal, such that the elastic bar is bent toward the substrate so as to contact with the substrate, which is mounted in the substrate mounting section, when the terminal is mounted in the terminal mounting section.

The above-described connector can be comprised of two substrates and a plurality of terminals. In this case, at least some of the terminals can be arranged between the two substrates, and contact with one of the substrates. Alternatively, the connector can be comprised of one substrate and a plurality of terminals. In this case, the plurality of terminals can be arranged above or below the substrate, and contact with the substrate at the upper or lower surface of the substrate. In the above connectors, the substrate can be a varistor array. In addition, this connector can have a metallic shell that covers the insulating housing, and the varistor array can be electrically connected to the metallic shell by contacting a part of the metallic shell protruding inside of the substrate mounting section with the varistor array when the varistor array is mounted in the substrate mounting section.

In this invention, the method for assembling the connector with a built-in substrate, which has an insulting housing, the terminal and substrate that are secured to the housing, is featured by that the mounting direction of the substrate in the substrate mounting section provided in the insulating housing is same as the mounting direction of the terminals in the terminal mounting section provided in the insulating housing.

According to the invention, there is provided a connector with a built-in substrate, which can be easily assembled and requires less number of components. In addition, the method for assembling such connector is also provided.

### BRIEF DESCRIPTION OF THE DRAWINGS

FIG. 1 is a perspective upper view of the connector with a built-in varistor according to the first embodiment of the invention.

FIG. 2 is a side view of the connector with a built-in varistor of FIG. 1.

FIG. 3 is a sectional view taken along line A-A of FIG. 1.

FIG. 4 is a sectional view of the connector taken along line A-A of FIG. 1 after the varistor array is secured in the connector.

FIG. 5 is a sectional view of the connector of FIG. 1 after the terminals are secured therein.

FIG. 6 is a perspective view of the connector with a built-in varistor, which is viewed from the fitting direction to the counter connector.

FIG. 7 is a sectional view illustrating the connector before fitting to the counter connector.

FIG. 8 is a sectional view illustrating the connector after fitting to the counter connector.

FIG. 9 is a perspective upper view of the connector with a built-in varistor according to the second embodiment of this invention.

FIG. 10 is a side view of the connector with a built-in varistor of FIG. 9.

FIG. 11 is a sectional view taken along line B-B of FIG. 9.

FIG. 12 is a sectional view of the connector taken along line B-B of FIG. 9 after the varistor is secured therein.

FIG. 13 is a sectional view of the connector taken along line B-B of FIG. 9 after the terminals are secured therein.

### DESCRIPTION OF THE PREFERRED EMBODIMENTS

Embodiments of the invention will now be described with reference to the accompanying drawings. As a preferred embodiment of this invention, a connector with a built-in varistor, which has a varistor array (substrate) will be described as an example. The varistor array is formed so as to have a plurality of pads by printing metal patterns on a aluminum substrate. When current larger than specified amount flows to the pads, excess current flows outside by the varistor array. For example, if such connector with a built-in varistor is used in a mobile notebook computer or a cellular phone, which is easily touched by the user, it can be prevented that the internal IC is destroyed by undesired current, such as static electricity caused by the user.

Here, the connector with a built-in varistor described below shows an example of the connector with a built-in substrate of this invention. The connector with a built-in substrate of this invention can be applied for various connectors. For example, if a condenser substrate is used as the substrate in place of the varistor array, a connector with a built-in substrate, which has an additional function of preventing radiation noise, can be provided. Therefore, this invention is not limited to the connector with a built-in varistor.

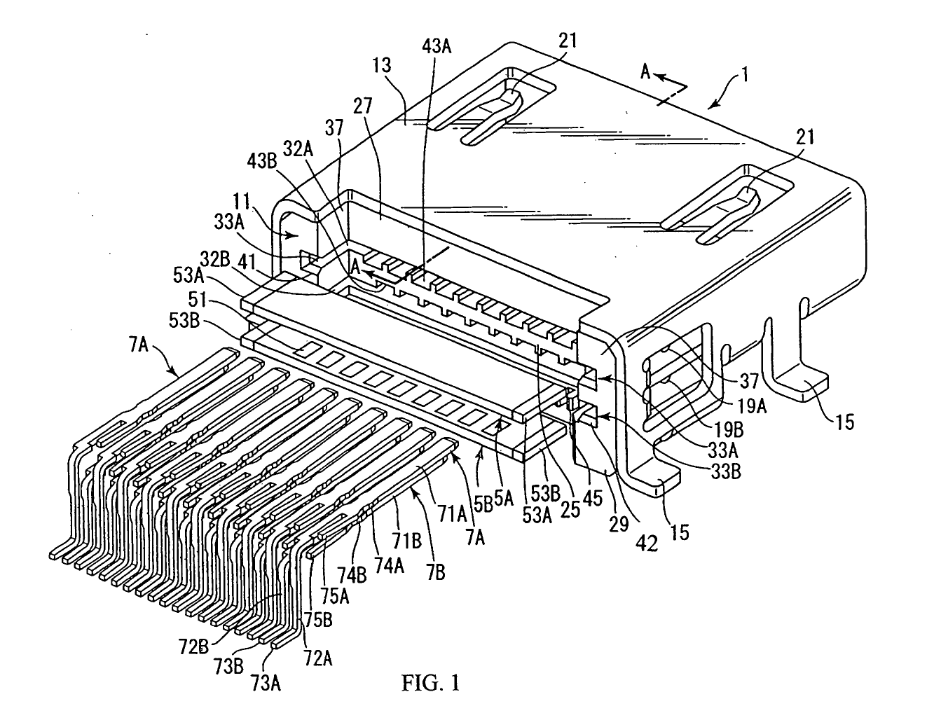

In FIGS. 1 and 2, the connector with a built-in varistor 1 is comprised of a insulating housing 11 made of a resin or from other materials, a metallic shell 13 that covers the outer surfaces of the insulating housing 11, two varistor arrays 5A and 5B and a plurality (two types) of terminals 7A and 7B, which are provided inside the insulating housing 11. Here, in FIGS. 1 and 2, the varistor arrays 5A and 5B and the terminals 7A and 7B are not secured in the insulating housing 11.

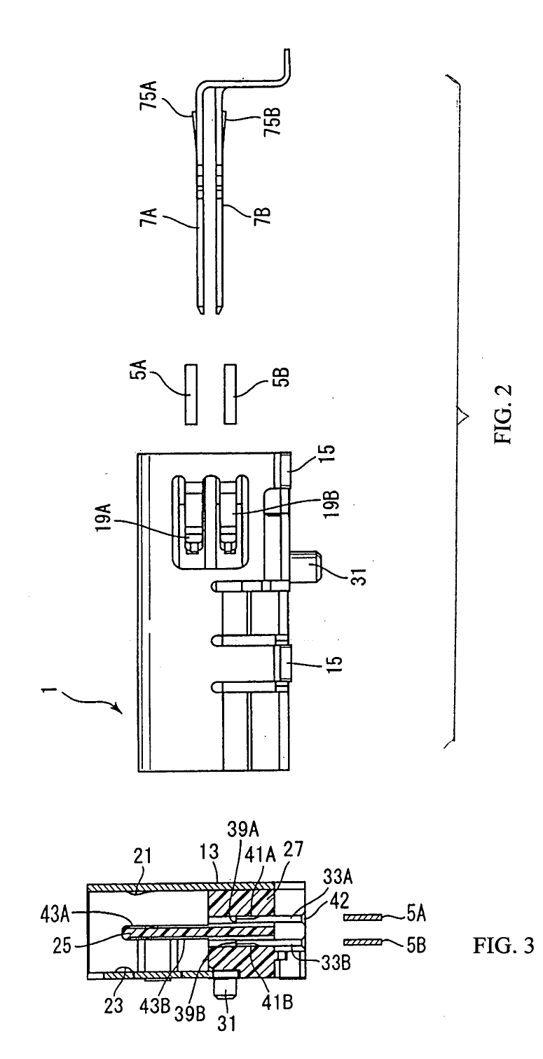

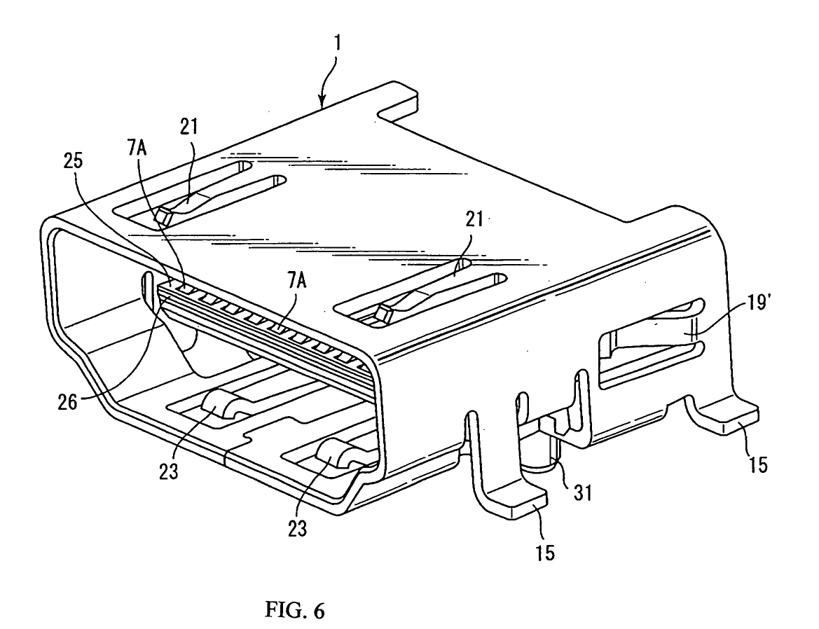

In order to further show the inner structure of the connector with a built-in varistor, sectional views of the connector with a built-in varistor are illustrated in FIGS. 3-5. The metallic shell 13 is secured onto the insulating housing in advance before the varistor arrays 5A and 5B and the terminals 7A and 7B are mounted in the insulating housing 11. By attaching the metallic shell 13 to the insulating housing 11, the mechanical strength of the insulating housing can be improved, and the connector can be protected from electromagnetic interference. Furthermore, since the metallic shell 13 will be connected to the varistor array 5A and 5B, current flowed from the varistor arrays 5A and 5B can be connected to ground.

Four soldering sections 15 (only two soldering sections are shown in FIGS. 1 and 2) which extend outward of the metallic shell 13 are provided at lower portions of the side surfaces of the metallic shell 13. The metallic shell 13 is secured and mounted on a circuit board via the soldering sections 15 and connected to ground. The soldering sections 15 can be formed by bending as illustrated in FIG. 1, or can be formed without bending.

In order to contact the varistor arrays 5A and 5B with the metallic shell 13, two pairs of elastic contact sections 19A and 19B are provided on the left and right side surfaces of the metallic shell 13 at the height level of the slits 33A and 33B of the insulating housing 11. Those elastic contact sections 19A and 19B are formed by cutting a part of the metallic shell 13, and bending to form V-shape toward the inside of the metallic shell 13. As a result, when the varistor arrays 5A and 5B are mounted in the insulating housing 11, to which the metallic shell 13 is attached, each pair of the elastic contact sections 19A and 19B can respectively elastically contact with the ground pads 53A and 53B on the side surfaces of the varistor arrays 5A and 5B. Accordingly, the metallic shell 13 and the varistor arrays 5A and 5B are electrically connected to each other. In addition, the varistor arrays 5A and 5B are connected to ground via the metallic shell 13.

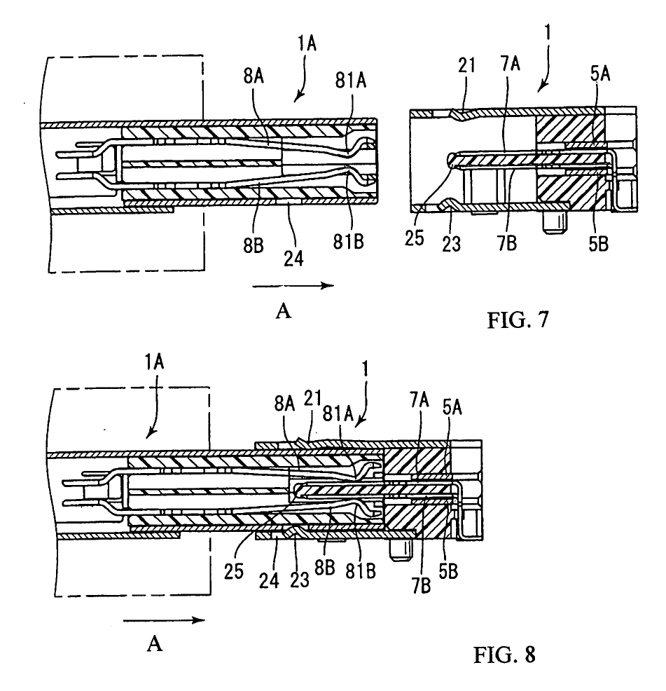

An elastic pressing sections 21 are symmetrically provided at left and right portions of the upper surface of the metallic shell. Those elastic pressing sections 21 are formed by cutting out a part of the upper surface of the metallic shell, and bending a portion formed by the cutting downward toward the inside of the metallic shell 13. When the connector of this invention 1 is fitted to the counter connector 1A (illustrated in FIGS. 7 and 8, which will be described later), those elastic pressing sections 21 presses the upper surface of the counter connector 1 and maintain the fitting.

Elastic catching sections 23 are symmetrically provided at left and right portions of the bottom surface of the metallic shell 13 (illustrated FIGS. 3-5 and 6). Those elastic engaging sections 23 are formed by cutting a part of the lower surface of the metallic shell 13, and bending the portion formed by cutting upward toward the inside of the metallic shell 13. When the connector 1 of this invention is fitted to the counter connector 1A (illustrated in FIGS. 7 and 8, which will be described later), those elastic catching sections 23 are fitted in the fitting holes 24 provided on the bottom surface of the counter connector, and maintain the fitting to the counter connector.

The insulating housing 11 is comprised of an intermediate arranging plate 25 provided at the middle height level of the insulating housing 11, an upper housing 27 and a lower housing 29, which are respectively provided above and below the intermediate arranging plate 25. The intermediate arranging plate 25 is provided so as to extend from the direction of mounting the varistor arrays 5A and 5B and the terminals 7A and 7B toward the rear portion inside the insulating housing 11. The upper housing 27 and the lower housing 29 are provided only near front portion of the insulating housing 11. Cylindrical protrusions 31 for positioning the connector 1 to a circuit board (not illustrated) protrude from the bottom surface of the insulating housing 11.

The varistor arrays 5A and 5B are mounted in the gaps 32A and 32B, which are respectively formed between the intermediate arranging plate 25 and the upper housing 27 of the insulating housing 11 and between the intermediate arranging plate 25 and the lower housing 29. By using two varistor arrays 5A and 5B, the terminals can be arranged at narrower pitch than when only one varistor array is used. The varistor arrays have same shape, and have a plurality of pads arranged in a row along the longitudinal direction on each side. Here, in the figure, only pads of the varistor array 5A are illustrated.

In order to guide the varistor arrays 5A and 5B into the insulating housing 11, two sets of slits 33A and 33B are provided in the insulating housing 11. Those slits 33A and 33B are formed so as to extend from the left and right protruded portions, which protrude slightly forward than the front center of the insulating housing 11, towards the rear portion in the insulating housing 11. With those slits 33A and 33B, the varistor arrays 5A and 5B are guided into the insulating housing 11. Inclined sections 42 are provided near the opening of the slits 33A and 33B, so that the varistor arrays 5A and 5B can be smoothly guided in the slits 33A and 33B. The slits 33A and 33B extend to middle parts of the upper housing 27 and the lower housing 29, and stopping sections 39A and 39B are provided at the ends of the slits 33A and 33B.

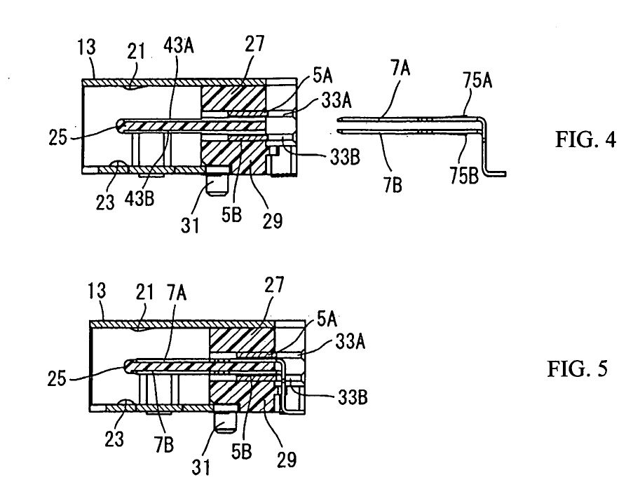

In order to secure the varistor arrays 5A and 5B into specified positions in the insulating housing, positioning members are provided before the stopping sections 39A and 39B. As the positioning members, press-in ribs (see FIGS. 3 and 4) are used in this embodiment. The press-in ribs 41A and 41B are provided along the direction of mounting the varistor arrays 5A and 5B symmetrically at left and right portions of the lower surface of the upper housing 27, and symmetrically at left and right portions of the upper surface of the lower housing 29. Those press-in ribs are provided so as to extend from the front center portion toward the rear portion of the insulating housing 11. Those press-in ribs 41A and 41B can be provided at the slits 33A and 33B. While pressing the press-in rib 41A and 41B, each varistor array 5A and 5B is pressed into the insulating housing 11, and secured therein. By providing those press-in ribs 41A and 41B, additional member for securing the varistor arrays 5A and 5B in the insulating housing 11 is not necessary. When the varistor arrays 5A and 5B are pressed in the insulating housing 11, the upper varistor array 5A is secured therein being pressed downward by the press-in rib 41A provided at the upper housing 27. On the other hand, the lower varistor array 5B is secured being pressed upward by the press-in rib 41B provided at the lower housing 29. By pressing those varistor arrays in this way, the connection to the terminals 7A and 7B can be effectively ensured.

After mounting the varistor arrays 5A and 5B, the terminals 7A and 7B are mounted in the insulating housing 11. The direction to mount the terminals 7A and 7B into the insulating housing 11 is same as that to mount the varistor arrays 5A and 5B into the insulating housing 11. Therefore, those mounting processes can be done very easily.

The terminals 7A and 7B are mounted using the grooves provided on the intermediate arranging plate 25 and the lower housing 29 of the insulating housing 11. The upper surface and the lower surface of the intermediate arranging plate 25 have a plurality of horizontal terminal grooves 43A and 43B in the extending direction of the intermediate arranging plate 25. The front side of the lower housing 29 has a plurality of vertical terminal grooves 45 in the vertical direction. The horizontal terminal grooves 43A on the upper surface of the intermediate arranging plate 25 and the horizontal terminal grooves 43B on the lower surface of the intermediate arranging plate 25 are staggered by half pitch of the width of the terminals with respect to each other. Accordingly, when the terminals are mounted in the terminal grooves and aligned, the terminals 7A aligned on the upper surface and the terminals 7B aligned on the lower surface are also staggered with respect to each other.

The terminals 7A and 7B mounted in the insulating housing 11 are grouped into two types. One is first terminals, which are aligned by the horizontal terminal grooves on the upper surface of the intermediate arranging plate 25, and the other is second terminals, which are aligned by the vertical terminal grooves 43 on the lower surface of the intermediate arranging plate 25. Each of those terminals is comprised of an extending section 71A or 71B, arranging section 72A or 72B to be arranged in the vertical arranging groove, and a soldering section 73A or 73B to be connected to the circuit board. The length of the extending section 71A or 71B is generally same as that of the intermediate arranging plate 25. When the first terminals 7A and the second terminals 7B are mounted in the insulating housing 11, the ends of extending sections 71A and 71B reach substantially same position as the end 26 of the intermediate arranging plate 25 of the insulating housing 11. The length of the arranging section 72A of each first terminal 7A is set slightly longer than that of the arranging sections of each second terminal. Those terminals 7A and 7B can be pressed in the horizontal terminal grooves by the press-in protrusions 74A and 74B provided at the extending section 71A and 71B, and then secured therein.

In order to securely contact the first and the second terminals 7A and 7B with the varistor arrays 5A and 5B in the insulating housing 11, the base portions of the extending sections 71A and 71B of the first terminals 7A and the second terminals 7B are split into two portions. One of the split portions is formed as an elastic bar 75A or 75B that has a free end in a direction opposite to the inserting direction to the insulating housing 11. The elastic bar of the first terminal 7A is formed by bending upward so as to securely contact with the varistor array 5A mounted at the upper portion of the insulating housing 11. On the other hand, the elastic bar 75B of the second terminal 7B is formed by bending downward so as to securely contact with the varistor array mounted in the lower portion of the insulating housing 11.

When the varistor arrays 5A and 5B and the terminals 7A and 7B are mounted in the insulating housing 11, each pad of each varistor array 5A or 5B elastically contacts one-to-one to each elastic bar 75A or 75B of each terminal 7A or 7B. Those elastic contacts are securely made by pressing the varistor arrays 5A and 5B toward the terminals 7A and 7B, and bending the elastic bars 75A and 75B of the terminals 7A and 7B toward the varistor arrays 5A and 5B, as described above.

FIG. 6 is a perspective upper view of the connector with a built-in varistor 1 of this invention, which is viewed from the fitting direction to the counter connector. FIGS. 7 and 8 illustrate the method of fitting the connector to the counter connector, which is similar to the method illustrated in FIGS. 3-5. FIG. 7 shows the connector before fitting to the counter connector, and FIG. 8 shows the connector after fitting to the counter connector. Here, FIGS. 6-8 are different from FIG. 1, and illustrate the connector after it is completely assembled.

As apparent from those figures, the intermediate arranging plate 25 and the terminals 7A and 7B arranged on the upper and lower surfaces of the intermediate arranging plate 25 extend to rear middle portion of the metallic shell 13. The connector of this invention is fitted to the counter connector 1A from the side opposite to the side for mounting the varistor arrays 5A and 5B and the terminals 7A and 7B into the insulating housing 11. The fitting direction (the direction of Arrow A in the figure) is parallel to the direction of mounting the varistor arrays 5A and 5B and the terminals 7A and 7B into the insulating housing 11. When the curved contact sections 81A and 81B of the terminals 8A and 8B of the counter connector 1A reach the terminals 7A and 7B of this invention by fitting the connector to the counter connector, the terminals 7A and 7B of this invention contact with the terminals 8A and 8B of the counter connector 1A being elastically clamped between the two terminals 8A and 8B. In addition, when the counter connector 1A is inserted into the connector 1 of this invention for some degree, the counter connector 1A is clamped between the elastic pressing section 21 and the elastic engaging section 23, which are provided on the connector 1 of this invention. Once the counter connector 1A is completely fitted to the connector 1A of this invention, the elastic engaging section 23 of the connector 1 of this invention is clicked in the fitting hole 24 provided on the metallic shell 13 of the counter connector 1A, and the engagement is maintained.

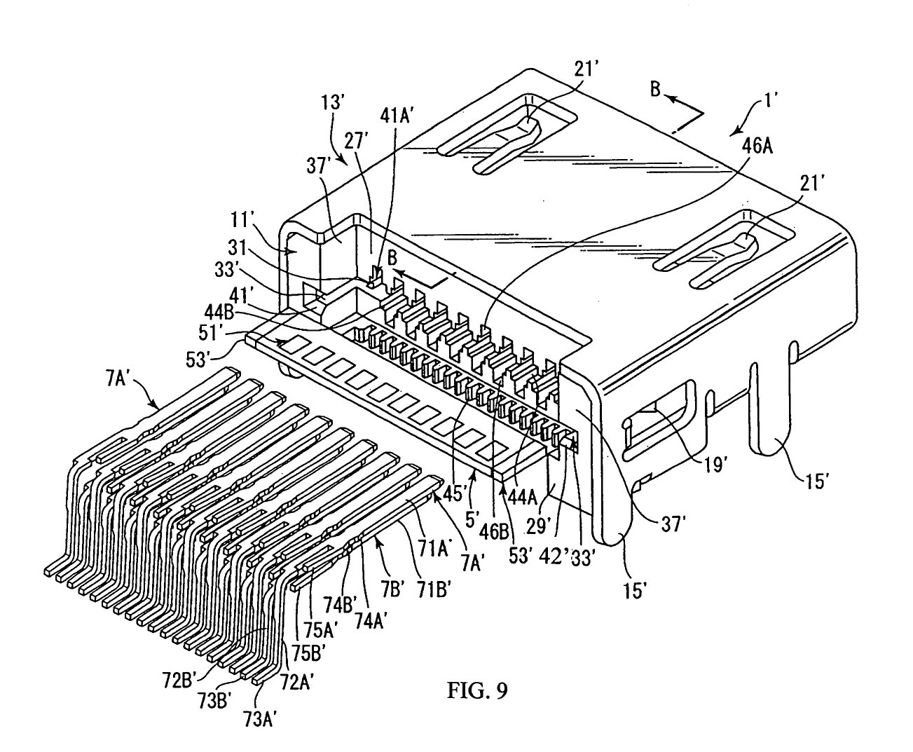

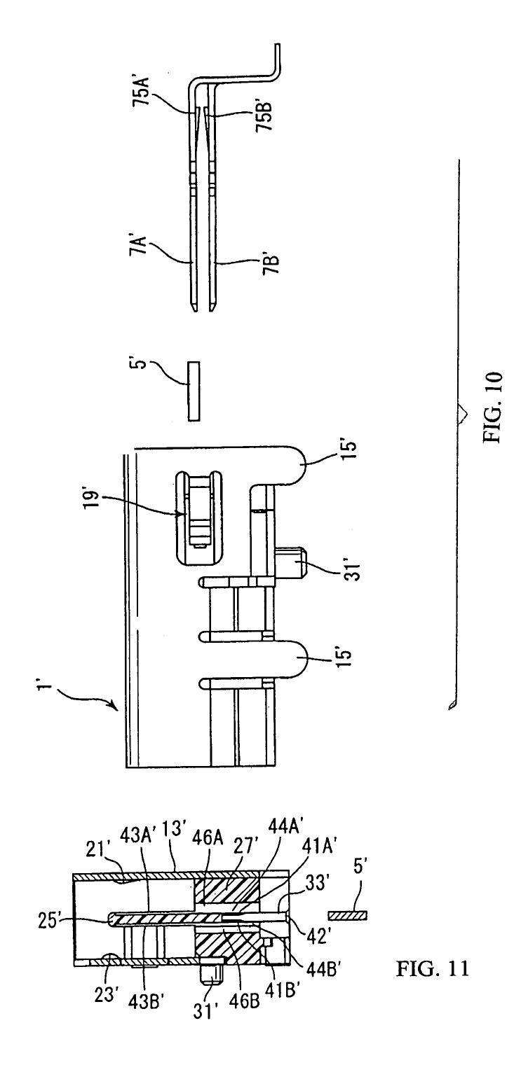

Referring now to FIGS. 9-13, the second embodiment of this invention will be described below. FIGS. 9-13 respectively correspond to FIGS. 1-5, which illustrate the first embodiment described above. Hereinafter, the difference of the second embodiment from the first embodiment will be mainly described. Here, members similar to those in the first embodiment, it is denoted by putting an apostrophe (') after the reference numerals, and detailed explanation will be omitted.

The difference between the first embodiment and the second embodiment is that only one varistor array is used in the second embodiment, while two varistor arrays are used in the first embodiment. Since only one varistor array is used in this embodiment, the varistor array 5′ has pads on the both sides to contact with the terminals 7A′ and 7B′. In addition, since only one varistor is provided, only one set of slits 33′ is provided for mounting the varistor array 5′ into the insulating housing 11′, and only one set of elastic contact sections 19′ is provided on the metallic shell 13′.

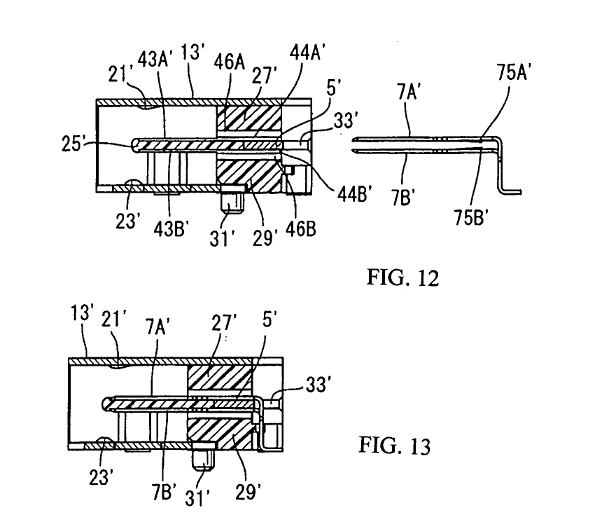

The insulating housing 11′ is comprised of the intermediate arranging plate 25′ provided at the middle height level of the insulating housing 11′, and the upper housing 27′ and the lower housing 29′, which are respectively provided above and below the intermediate arranging plate 25′, as main elements. Therefore, in the second embodiment, the varistor array 5′ is mounted in the gap formed between the upper housing 27′ and the lower housing 29′. In other words, the varistor array 5′ is mounted in the insulating housing at the same height level as that of the intermediate arranging plate 25′. As fully illustrated in FIG. 12, the varistor array mounted in the gap 31 is continuously connected to the intermediate arranging plate, which is positioned at rear portion in the insulating housing 11′.

The terminals 7A′ and 7B′ are mounted in the insulating housing using the grooves provided on the intermediate arranging plate 25′ and the upper housing 27′ for the terminals 7A′ and the grooves provided on the intermediate arranging plate 25′ and the lower housing 29′ for the terminals 7B′. More specifically, in the second embodiment, in addition to the horizontal terminal grooves 43A′ and 43B′ provided on the upper and the lower surfaces of the intermediate arranging plate 25′, another horizontal grooves 44A and 44B are provided on the lower surface of the upper housing 27′ and the upper surface of the lower housing 29′, respectively. The horizontal terminal grooves 43A′ and 44A, which are respectively provided on the upper surface of the intermediate arranging plate 25′ and the lower surface of the upper housing 27′, are continuously connected to each other. Similarly, the horizontal grooves 43B′ and 44B, which are respectively provided on the lower surface of the intermediate arranging plate 25′ and the upper surface of the lower housing 29′, are continuously connected to each other. In order to enable smooth mounting of the terminals 7A′ and 7B′ into the horizontal terminal grooves 44A and 44B of the upper housing 27′ and the lower housing 29′, a deeper slot is provided along the middle portion of each horizontal terminal grooves 44A or 44B.

The press-in ribs 41A′ and 41B′ are provided symmetrically at left and right portion on the lower surface of the upper housing 27′ and symmetrically at left and right portions on the upper surface of the lower housing 29′, along the mounting direction of the varistor array 5′. As a result, when the varistor array 5′ is mounted between the upper housing 27′ and the lower housing 29′, the varistor array 5′ receives generally equal amount of force from the upper housing 27′ and the lower housing 29′. Therefore, the varistor array 5′ is secured at the intermediate position of the insulating housing 11′, i.e. at substantially same height level as that of the intermediate arranging plate 25′. By securing the varistor array 5′ at such position, it can securely contact with all the upper and lower terminals 7A′ and 7B′.

As easily understood, alterations or variations of this invention can be made by a person skilled in the art. For example, the number of substrates is not limited to one or two, but three or more substrates can be used in the connector. Therefore, it should be understood that all those alterations and variations are included in the scope of this invention. This invention can be widely used in a connector with a built-in substrate.

1. A connector with a built-in substrate, comprising:
an insulating housing;
a terminal secured in said insulating housing; and
a substrate secured in said housing,
wherein said insulating housing is comprised of a substrate mounting section to mount said substrate therein, and a terminal mounting section to mount said terminal in said insulating housing, and the direction of mounting said substrate in the substrate mounting section is same as that of mounting said terminal in said terminal mounting section.

2. The connector according to claim 1, wherein said substrate mounting section has a positioning member for positioning said substrate in said substrate mounting section when said substrate is mounted in said substrate mounting section.

3. The connector according to claim 2, wherein said positioning member is a press-in rib, which is provided along the mounting direction of said substrate so as to press in and secure said substrate in said insulating housing being pushed by said substrate when said substrate is mounted in said substrate mounting section.

4. The connector according to claim 1, wherein said terminal has an elastic bar having a free end, which is bent toward said substrate so as to contact with said substrate mounted in said substrate mounting section when said terminal is mounted in said terminal mounting section.

5. The connector according to claim 1, wherein two substrates and a plurality of terminals are respectively used as said substrate and said terminal, and some of said plurality of terminals is arranged between said two substrate and contacts at least one of said two substrates.

6. The connector according to claim 1, wherein one substrate and a plurality of terminals are respectively used as said substrate and said terminal, and said plurality of terminals are arranged at the upper and the lower portions of said substrate, and contact with said substrate at the upper surface or lower surface of said substrate.

7. The connector according to claim 1, wherein said substrate is a varistor array.

8. The connector according to claim 7, wherein said connector further comprising:
a metallic shell, which covers said insulating housing,
wherein said varistor array contacts and is electrically connected to a part of said metallic shell when said varistor arrays is mounted in said substrate mounting section.

9. A method of assembling a connector with a built-in substrate, wherein said connector is comprised of an insulating housing, and a terminal and a substrate, which are secured in said insulating housing, and the direction of mounting said substrate in, a substrate mounting section provided on said insulating housing is same as that of mounting said terminal in a terminal mounting section provided on said insulating housing.

10. The connector according to claim 2, wherein said terminal has an elastic bar having a free end, which is bent toward said substrate so as to contact with said substrate mounted in said substrate mounting section when said terminal is mounted in said terminal mounting section.

11. The connector according to claim 3, wherein said terminal has an elastic bar having a free end, which is bent toward said substrate so as to contact with said substrate mounted in said substrate mounting section when said terminal is mounted in said terminal mounting section.

12. The connector according to claim 2, wherein two substrates and a plurality of terminals are respectively used as said substrate and said terminal, and some of said plurality of terminals is arranged between said two substrate and contacts at least one of said two substrates.

13. The connector according to claim 3, wherein two substrates and a plurality of terminals are respectively used as said substrate and said terminal, and some of said plurality of terminals is arranged between said two substrate and contacts at least one of said two substrates.

14. The connector according to claim 4, wherein two substrates and a plurality of terminals are respectively used as said substrate and said terminal, and some of said plurality of terminals is arranged between said two substrate and contacts at least one of said two substrates.

15. The connector according to claim 2, wherein one substrate and a plurality of terminals are respectively used as said substrate and said terminal, and said plurality of terminals are arranged at the upper and the lower portions of said substrate, and contact with said substrate at the upper surface or lower surface of said substrate.

16. The connector according to claim 3, wherein one substrate and a plurality of terminals are respectively used as said substrate and said terminal, and said plurality of terminals are arranged at the upper and the lower portions of said substrate, and contact with said substrate at the upper surface or lower surface of said substrate.

17. The connector according to claim 4, wherein one substrate and a plurality of terminals are respectively used as said substrate and said terminal, and said plurality of terminals are arranged at the upper and the lower portions of said substrate, and contact with said substrate at the upper surface or lower surface of said substrate.

18. The connector according to claim 2, wherein said substrate is a varistor array.

19. The connector according to claim 3, wherein said substrate is a varistor array.

20. The connector according to claim 4, wherein said substrate is a varistor array.
